(19) United States
(12) Patent Application Publication
(10) Pub. No.: US 2019/0158879 A1
(43) Pub. Date: May 23, 2019

(54) SUCCESSIVE REFINEMENT VIDEO COMPRESSION

(71) Applicant: Amimon Ltd., Ra'anana (IL)

(72) Inventor: Zvi Reznic, Tel Aviv (IL)

(21) Appl. No.: 16/255,846

(22) Filed: Jan. 24, 2019

Related U.S. Application Data
(63) Continuation-in-part of application No. PCT/IB2017/054745, filed on Aug. 3, 2017.
(60) Provisional application No. 62/370,254, filed on Aug. 3, 2016.

(51) Int. Cl. H04N 19/66; H04L 29/06; H04N 19/91

(52) U.S. Cl. CPC H04N 19/66; H04N 19/91; H04L 65/607; H04L 65/80

(57) ABSTRACT

A method of transmitting compressed video data includes: encoding video data; generating coarse data and refinement data from the video data; packetizing the coarse data into a first packet; and successively packetizing the refinement data into a plurality of packets. Each successive packet of the plurality of packets includes a finer description of the refinement data relative to the previous packet.

### CROSS-REFERENCE TO RELATED APPLICATIONS

This patent application is a Continuation-in-Part (CIP) of PCT international application number PCT/IB2017/054745, having an international filing date of Aug. 3, 2017, published as International Publication number WO 2018/025211 A1, which is hereby incorporated by reference in its entirety; which claims benefit and priority from U.S. 62/370,254, filed on Aug. 3, 2016, which is hereby incorporated by reference in its entirety.

### FIELD

The present invention relates to video compression generally and to a system for successive refinement video compression.

### BACKGROUND

Data compression is typically used to compress video data prior to transmission over a communication network or prior to storing the data in a storage medium. It may allow for a reduction in transmission bandwidth, in the amount of storage space, and in transmission time.

Video data may generally be represented as a series of still image frames. The sequence of frames may contain spatial and temporal redundancy that video compression algorithms may attempt to eliminate or code in a smaller size by means of an encoder. The encoder may store data associated with differences between frames or associated with perceptual features of human vision, and may generate compressed video data only with this data.

Compressed video data is generally delivered in packets. These packets may get lost during transmission, or may be otherwise affected so that there is an error in the video data transmitted in the packet. Packets which are not successfully received are generally retransmitted if the receiving side does not acknowledge successful receipt of the packet.

### SUMMARY

There is provided, in accordance with an embodiment of the present invention, a method of transmitting compressed video data, the method may include encoding video data, generating coarse data and refinement data from the video data, packetizing at least a portion of the coarse data into a first packet, and successively packetizing at least a portion of the refinement data into a plurality of packets, wherein each successive packet of the plurality of packets may include a finer description of the refinement data relative to the previous packet.

In some embodiments, the video data may include video content and any one of audio content and control data.

In some embodiments, the method additionally may include transmitting the first packet and the plurality of packets within a time window of length K milliseconds.

In some embodiments, the method additionally may include cancelling transmission of one or more of the first and the plurality of packets not successfully transmitted within the time window.

In some embodiments, the method additionally may include decoding the data in successfully received packets.

In some embodiments, the method additionally may include buffering the coarse data.

In some embodiments, the method additionally may include buffering the refinement data.

In some embodiments, the method additionally may include converting the video data from RBC to YCrCb format.

In some embodiments, the method additionally may include performing Chroma sub-sampling on the video data.

In some embodiments, the method additionally may include performing predictions on the video data.

In some embodiments, the method additionally may include performing transform operations on the video data.

In some embodiments, the transform operations include discrete cosine transforms (DCT).

In some embodiments, the method additionally may include identifying static blocks generated from the video data.

In some embodiments, the method additionally may include identifying dynamic blocks generated from the video data.

In some embodiments, the method may include grouping dynamic blocks generated from the video data into superblocks.

In some embodiments, the superblocks include a plurality of transform blocks.

In some embodiments, the method may include companding the video data.

In some embodiments, the method may include multiplying the video data by a Hadamard matrix.

In some embodiments, the method may include normalizing a power of all superblocks generated from the video data.

There is provided, in accordance with an embodiment of the present invention, a system for transmitting compressed video data including a low latency encoder suitable for encoding video data, generating coarse data and refinement data from the video data, packetizing at least a portion of the coarse data into a first packet, and successively packetizing at least a portion of the refinement data into a plurality of packets, wherein each successive packet of the plurality of packets may include a finer description of the refinement data relative to the previous packet. The system additionally may include means to successively transmit the first packet and the plurality of packets, a low latency decoder, and means to receive the first packet and said plurality of packets.

In some embodiments, the video data may include video content and may include any one of audio content and control data.

In some embodiments, the first packet and the plurality of packets are transmitted within a time window of length K milliseconds.

In some embodiments, transmission of one or more of the first and the plurality of packets not successfully transmitted within the time window is cancelled.

In some embodiments, the decoder decodes the data in successfully received packets.

In some embodiments, the encoder may include a coarse data buffer.

In some embodiments, the encoder may include a refinement data buffer.

In some embodiments, the encoder may include an RGB/YCrCb module.

In some embodiments, the encoder may include a Chroma sub-sampling module.

In some embodiments, the encoder may include a predictions module.

In some embodiments, the encoder may include a transform operations module. The transform operations may include discrete cosine transforms (DCT).

In some embodiments, the encoder may include a static/dynamic blocks classifier module.

In some embodiments, the encoder may include a VLF (variable length fine) module.

In some embodiments, the encoder may include a compander module.

In some embodiments, the encoder may include a CFP (constant fine power) module.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a low latency successive refinement video compression system, according to an embodiment of the present invention;

FIG. 2 schematically illustrates an exemplary architecture of the low latency encoder of FIG. 1, according to an embodiment of the present invention;

FIG. 3 schematically illustrates an exemplary mode of operation of a successive refinement coding module in the encoder of FIGS. 1 and 2, according to an embodiment of the present invention;

FIG. 4 schematically illustrates two examples of low latency packet transmission by the transmitter of FIG. 1, according to an embodiment of the present invention; and

FIG. 5 schematically illustrates an exemplary architecture for a successive refinement compression module in the encoder of FIGS. 1 and 2, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that a video compression system with an encoder which includes use of successive refinement compression and successive refinement coding may prove to be more effective compared to existing video compression systems. Successive refinement compression and successive refinement coding may be used to generate a series of packets containing a series of successive-refinement descriptions of the video. Each packet may be sent only if the previous packet was successfully received, and only within a pre-defined allowable time window. If not sent within the window, the packet may be discarded. The video compression system additionally includes a low latency decoder which may generate a video frame from a partial number of packets received from the encoder.

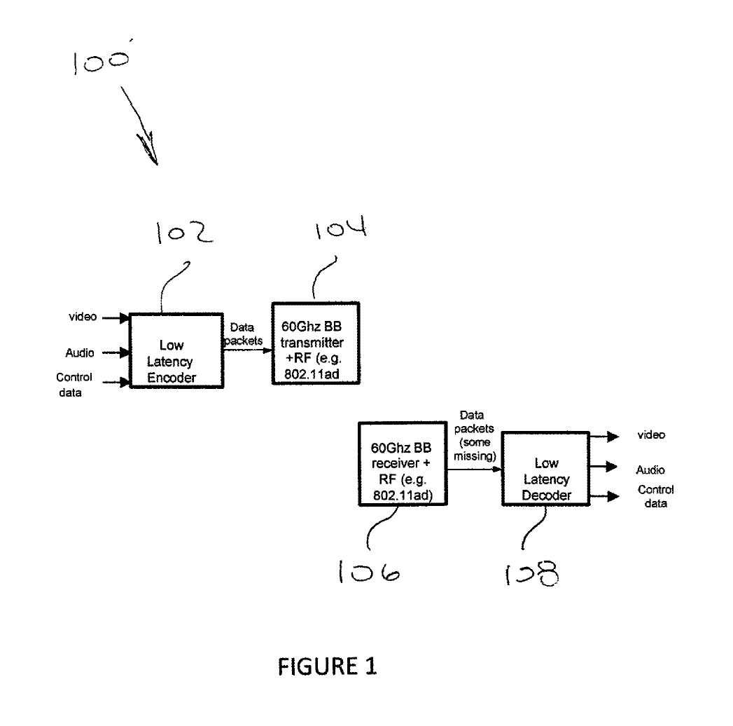

Reference is now made to FIG. 1 which schematically illustrates a low latency successive refinement video compression system 100, according to an embodiment of the present invention. System 100 comprises a low latency encoder 102, a transmitter 104, a receiver 106, and a decoder 108. An overall latency of system 100 may be low, and may be bounded by a certain upper threshold, or may be fixed.

Low latency encoder 102 may receive an input of one or more streams of video, and may additionally receive one or more streams of audio and/or data which may include control data. The video may be compressed, for example using H.265 compression, or may be uncompressed, or may include a combination of compressed description and uncompressed description. An output of the encoder 102 may be arranged in one or more packets per video frame, or per part of a video frame.

The output of encoder 102 may be transmitted by transmitter 104 which may include a 60 GHz broadband transmitter. In some embodiments, the output of encoder 102 may be transmitted using a different type of transmitter, for example, a Wi-Fi transmitter or a LTE or other cellular transmitter, or using other transmission means such as USB and Ethernet, among others. Alternatively, the output of encoder 102 can be stored in a storage medium.

The transmitted signal may be received by receiver 106, which may include a 60 GHz broadband receiver. In some embodiments, receiver 106 may include other types of receivers, such as for example, a Wi-Fi receiver, a LTE or other cellular receiver, or may include other reception means such as USB and Ethernet, among others. Alternatively, receiver 106 may include a reading device which may read the data from a storage medium.

Low latency decoder 108 may receive data packets sent by encoder 102. Decoder 108 may receive all the sent packets, or may receive only a portion of the sent packets. From the received packets, decoder 108 may generate one or more streams of video, and may generate one or more streams of audio and/or control data.

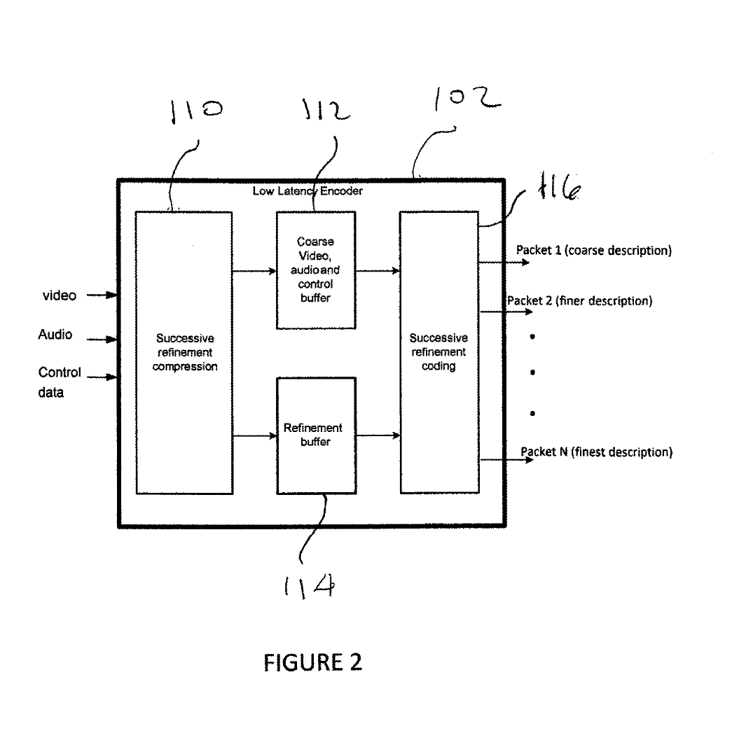

Reference is now made to FIG. 2 which schematically illustrates an exemplary architecture of low latency encoder 102, according to an embodiment of the present invention. Encoder 102 may include a successive refinement compression module 110, a coarse data buffer (coarse video, audio and control buffer) 112, a refinement data buffer (refinement buffer) 114, and a successive refinement coding module 116.

Successive refinement compression module 110 may receive the video streams and may additionally receive audio and/or control data streams. Successive refinement compression module 110 may process the video, audio and control data, and may generate two types of output data, coarse data and refinement data. The generated coarse data may be transferred to coarse data buffer 112, and the refinement data may be transferred to refinement data buffer 114.

Successive refinement coding module 116 may receive the data from coarse data buffer 112 and from refinement data buffer 114 and may generate one of more packets of data. The packets of data may be represented as packets of bit and may be identified as packets 1 to packet N. Successive refinement coding module 116 may include use of lossless compression schemes in generating the packets. These may include entropy coding, Huffman coding, Exponential-Golomb coding, context-adaptive coding, variable length coding, fixed-rate coding, arithmetic coding, among other types of coding.

Packet 1 may include a coarse description of the video, audio and control data. Packet 2 may include a finer description of the video, audio and control data. Alternatively, packet 2 may include refinement data such that the combination of packet 1 and packet 2 includes a description of the video, audio and control data which is finer than the description provided by packet 1 alone. Packet 3 may include data which is a finer description than that of packet 2, or finer refinement than packet 2. In the latter case, the combination of packet 1, packet 2 and packet 3 may include a description of the video, audio and control, which is finer than the combination of only packet 1 and packet 2. This process of further refinement may be repeated for all the remaining packets, up to packet N which is the last packet.

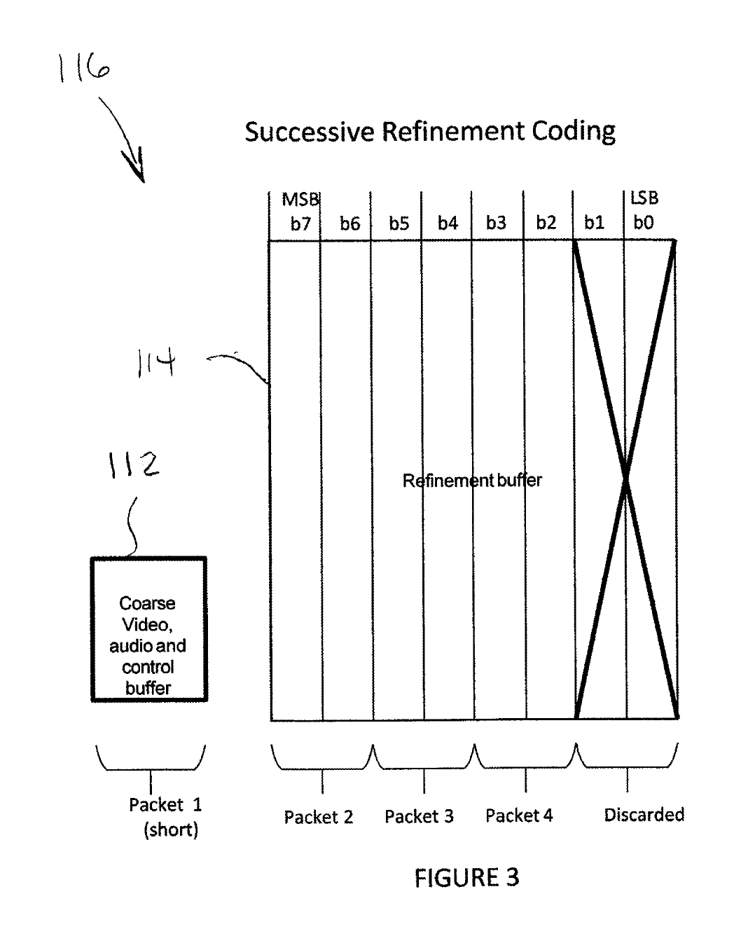

Reference is now made to FIG. 3 which schematically illustrates an exemplary mode of operation of the successive refinement coding module 116, according to an embodiment of the present invention. Refinement data buffer 114 may include a list of 8 bits numbers.

Successive refinement coding module 116 may packetize the data from coarse data buffer 112 as packet 1. Successive refinement coding module 116 may then packetize the two most-significant bits (bits b7 and b6) of all the numbers in refinement data buffer 114 as packet 2. It may then packetize bits b5 and b4 of all the numbers in refinement data buffer 114 as packet 3. It may then packetize bits b3 and b2 of all the numbers in refinement data buffer 114 as packet 4. The two least-significant bits (bits b1 and b0) in refinement data buffer 114 may be discarded.

It may be appreciated that other methods of distribution of the data may be used. For example, the distribution between the packet may be such that packet M has higher visual importance than packet L, for every L<M.

Successive refinement coding module 116 may include a cascade of quantizers, where the quantization points of a quantizer M is coded and packetized in packet M, and the quantization error of quantizer M may be used as the input to quantizer M+1. The quantization cell size of quantizer M may typically be smaller than the quantization cell size of quantizer M+1. For higher order quantizers, a 1-bit quantizer may be used, where the cell size of each quantizer is half the size of the cell size of the previous quantizer in the cascade.

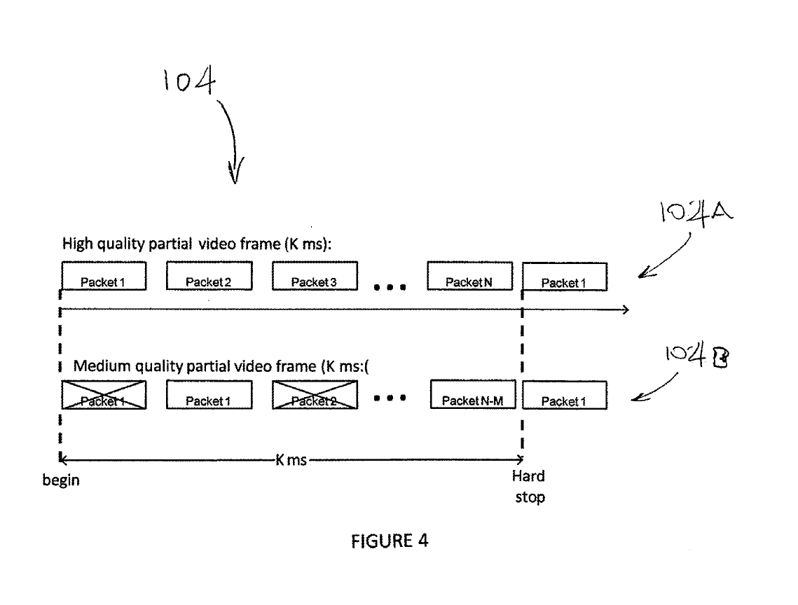

FIG. 4 schematically illustrates two examples of low latency packet transmission by transmitter 104, according to an embodiment of the present invention. To maintain bounded and fixed latency, the video content is divided into sections of length K ms, and the packets which describe that video part, may be sent during a time window which has a size of K ms. At the end of the K ms window, transmitter 104 may stop sending the current video section, and may start sending the next section. From the examples below, it may be appreciated that by properly selecting the window length K ms, total system latency may be controlled, and a low latency transmission may be achieved.

The first example, titled “high quality partial video frame (K ms)” and shown as 104A, shows transmitter 104 was able to successfully transmit all the N packets which were generated by low latency encoder 102 to describe the video section. A successful transmission may be indicated by an acknowledgment message transmitted in the opposite direction from receiver 106 to transmitter 104.

The second example, titled “medium quality partial video frame (K ms)” and shown as 104B, some of the transmitted packets, including packets 1 and 2 where not successful in the first trial. As a result, transmitter 104 may send them again (and possibly again and again), until an acknowledgement is received. Since re-transmissions occupy the channel, the result may be that at the end of the K ms window not all the packet are successfully transmitted, and only the first N-M packets where successfully received. As a result, decoder 108 may therefore reconstruct the image only from packets 1 through N-M. This will yield a reconstructed image which might be in lower quality than it would be if all the packets were decoded correctly.

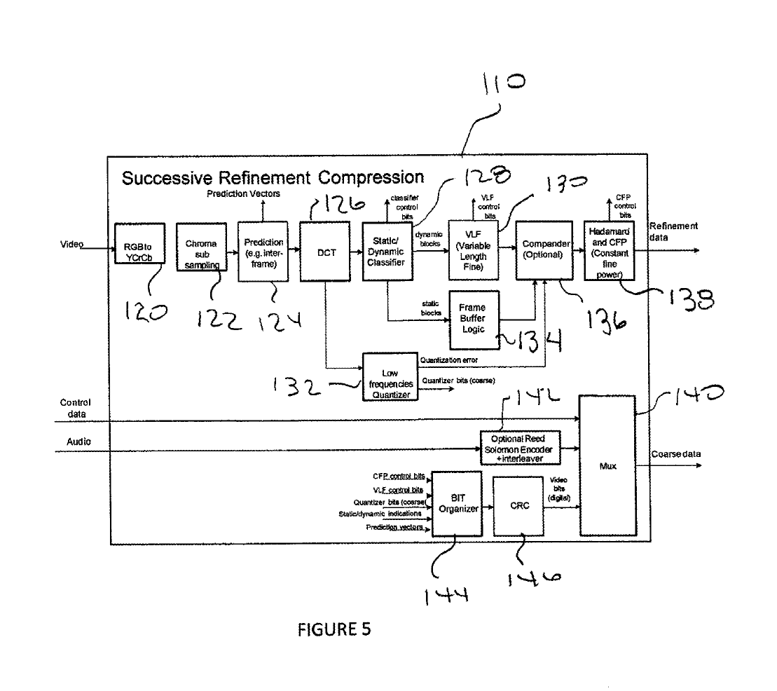

Reference is now made to FIG. 5 which schematically illustrates an exemplary architecture for successive refinement compression module 110, according to an embodiment of the present invention. Successive refinement compression module 110 may include a RGB/YCrCb module 120, an optional chroma sub-sampling module 122, a prediction module 124, a DCT module 126, a static/dynamic classifier 128, a VLF module 130, a low frequency quantizer module 132, a frame buffer logic module 134, an optional compander module 136, a CFP module 138, a MUX module 140, an optional FEC module (Reed Solomon Encoder and Interleaver) 142, a bit organizer module 144, and a CRC module 146.

RGB/YCrCb module 120 may convert the pixels in the incoming video data from RGB to YCrCb. Optional chroma-sub sampling module 122 may encode the YCrCb data and may reduce the image domain of the Cr and Cb by a factor of 2 (or greater) in either one dimension or in two dimensions (in the case of two dimensions, the factor is 2 in each dimension).

Prediction module 124 may predict certain parts of the video frame from previously-encoded parts. The prediction scheme may include interframe prediction, although other schemes may be used. The previously encoded parts can be either in other frames, or in other views such as, for example, in Multiview video system (used in 3D Virtual-Reality head-mounted-displays), or in other parts of the current frame. The output of prediction module 124 may be fed to DCT module 126 which may perform a two-dimensional DCT (discrete cosine transform) operation on the data. It may be appreciated that other transform operations may be performed on the data in lieu of DCT.

Static/dynamic classifier module 128 may determine for each transform block, for example, an 8×8 DCT block, if it is identical to the same block in the previous frames or in a predicted frame, or if the transform block is different from it. This may be done even if transmitter 104 does not have a frame buffer that stores the previous frame by storing an attribute of each block in the previous frame. The attribute may include only few 10 s of bits per block. VLF (Variable Length Fine) block module 130 may group dynamic blocks into superblocks which may include up to several transform blocks, for example 240 dynamic blocks of 8×8 pixels.

For each superblock, successive refinement compression module 110 may decide which taps should be transmitted, and which taps may be omitted due to their low energy level. The decision regarding which taps to send and which not to send may be done under the condition that the total number of transmitted taps in a super block is fixed. Hence, each block may transmit a different number of taps, but the total taps for a superblock may remain fixed.

Frame buffer logic block 134 may process the static blocks. If a block is static, successive refinement compression module 110 may divide all the transform taps to several phases, for example 3-7 phases, and in each frame may send a different part of the transform taps. For example, if the total number of taps per block is 192, say 64 for Y, 64 for Cr and 64 for Cb, in frame N DCT taps 0-47 may be transmitted, in frame N+1 DCT taps 48-95 may be transmitted, in frame N+2 DCT taps 96-143 may be transmitted, and in frame N+3 DCT taps 144-191 may be transmitted.

On the receiving side, low latency decoder 108 may include a memory which may store the transform taps. Hence, in frame N an image that includes only taps 0-47 may be displayed, but in frame N+1 it will read from the memory taps 0-47 while receiving taps 48-95 from transmission, so it will be able to display an image that includes only taps 0-95. In the same manner it will be able to display an image that includes only taps 0-143 in frame N+2 and 0-191 (all DCT taps) in frame N+4.

Furthermore, in the above example, in frame N+4, the transmitter may send taps 0-47 again. The receiver may now have two copies of taps 0-47. The receiver may then average the two copies, and may use the average value both for displaying the image and for storing in memory.

The transform taps at the output of the VLF module 130 and at the output of the frame buffer logic module 134 may undergo a compander operation in optional compander module 136. Compander module 136 may implement a non-linear, monotonically non-decreasing function. For example, if the compander module 136 input is denoted as X and the compander module output as Y, and if X is bounded by −1024<X<1023, compander module may implement one of the following examples:

### Example 1

Y=sign(X)×sqrt(abs(X)/1024)×1024.

### Example 2

aX if |X|≤T;

Y=(sign Cx)·[C|X|−T)·b+aT] if |X|>T,

where T>0 is a certain threshold and usually a>0, b>0 and a<b.

CFP (Constant Fine Power) module 138 may normalize the output power by multiplying the transform taps in a superblock (optionally after compander module 136) by a gain factor, which may be selected separately for each superblock, such that the output power of all the superblocks may be essentially constant. CFP module 138 may also generate a message which may convey the gain of each superblock and which may be sent low latency decoder 108.

Prior to generating the refinement data, the successive refinement compression module 110 may multiply the data (mainly transform taps, optionally processed by compander module 136 and by CFP module 138) by a Hadamard matrix, or another suitable matrix which is known to receiver 106.

The prior description describes the portion of the architecture of successive refinement compression module 110 which may be used to generate the refinement data. Generation of the coarse data may include the following portion of the architecture of successive refinement compression module 110.

Low frequency quantizer 132 may quantize the low frequencies taps at the output of DCT module 126. The quantization error may be sent to compander module 136, and later to the refinement data stream. The indices of the quantization points may be referred to as “quantizer bits” and may form part of the coarse data.

The coarse data may consist of:

1. Control data, which is received as an input to successive refinement compression module 110;

2. Audio data which is received as an input to successive refinement compression module 110, and may optionally under forward error correction coding (or other error correction scheme) and interleaving in FEC module 142;

3. Prediction vectors generated by prediction module 124, and which may include, for example, motion vectors in inter-frame prediction;

4. VLF control bits generated by VLF module 130 and which may include the number of transform taps which are sent for each block;

5. CFP control bits generated by CFP module 138 and which may describe the gain applied to each super block;

6. Static/dynamic indications which may be generated by Static/Dynamic Classifier module 128 and which may indicate which block is static and which block is dynamic; and

7. Quantizer bits generated by low frequency quantizer 132.

Bit organizer module 144 may arrange the data associated with the prediction vectors, VLF control bits, CFP control bits, Static/dynamic indications, and quantizer bits into a format which may be suitable for transmission. CRC (cyclic redundancy check) module 146 may introduce a cyclic redundancy check code into the organized data from Bit Organizer 144 module. MUX (multiplexer) module 140 may multiplex the Control data, Audio data, and the output from Bit organizer module 144, for transmission as coarse data.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of transmitting compressed video data, the method comprising:
encoding video data;
generating coarse data from said video data;
generating refinement data from said video data;
packetizing at least a portion of said coarse data into a first packet; and
successively packetizing at least a portion of said refinement data into a plurality of packets, wherein each successive packet of said plurality of packets comprises a finer description of the refinement data relative to the previous packet.

2. The method of claim 1, further comprising:
transmitting said first packet and zero or more packets out of said plurality of packets within a time window having length of K milliseconds;
retransmitting one or more packets which were previously transmitted out of said plurality of packets, provided that said retransmitting is performed during said time window;
cancelling transmission of one or more of said first packet and said plurality of packets, which were not successfully transmitted within said time window.

3. The method of claim 1, wherein said video data comprises video content and any one of audio content and control data.

4. The method of claim 1, further comprising:
transmitting a first packet and also said plurality of packets within a time window having length of K milliseconds.

5. The method of claim 4, comprising:
cancelling transmission of one or more of said first packet and said plurality of packets, which were not successfully transmitted within said time window.

6. A system for transmitting compressed video data, the system comprising:
a low latency encoder that is configured to perform:
encoding video data;
generating coarse data from said video data;
generating refinement data from said video data;
packetizing at least a portion of said coarse data into a first packet; and
successively packetizing at least a portion of said refinement data into a plurality of packets, wherein each successive packet of said plurality of packets comprises a finer description of the refinement data relative to the previous packet;
means to successively transmit said first packet and said plurality of packets;
a low latency decoder; and
means to receive said first packet and said plurality of packets.

7. The system of claim 6, wherein the means to transmit is configured to perform:
transmitting said first packet and zero or more packets out of said plurality of packets within a time window having length of K milliseconds;
retransmitting one or more packets which were previously transmitted out of said plurality of packets, provided that said retransmitting is performed during said time window;
cancelling transmission of one or more of said first packet and said plurality of packets, which were not successfully transmitted within said time window.

8. The system of claim 6, wherein said video data comprises video content and any one of audio content and control data.

9. The system of claim 6, wherein said first packet and said plurality of packets are transmitted within a time window having length of K milliseconds.

10. The system of claim 6, wherein transmission of one or more of said first packet and said plurality of packets, that were not successfully transmitted within said time window, is cancelled.

11. The system of claim 6, wherein said decoder decodes the data in successfully received packets.

12. A low latency encoder configured to perform:
encoding video data;
generating coarse data from said video data;
generating refinement data from said video data;
packetizing at least a portion of said coarse data into a first packet; and
successively packetizing at least a portion of said refinement data into a plurality of packets, wherein each successive packet of said plurality of packets comprises a finer description of the refinement data relative to the previous packet.

13. The low latency encoder of claim 12, wherein said video data comprises video content and any one of audio content and control data.

14. The low latency encoder of claim 12, wherein said first packet and said plurality of packets are transmitted within a time window having length of K milliseconds.

15. The low latency encoder of claim 12, wherein transmission of one or more of said first and said plurality of packets, which were not successfully transmitted within said time window, is cancelled.

16. The low latency encoder of claim 12, further comprising:
a coarse data buffer to temporarily buffer said coarse data prior to packetization;
a refinement data buffer to temporarily buffer said refinement data prior to packetization.

17. The low latency encoder of claim 12, comprising:
a variable-length grouping module to group dynamic blocks into superblocks, wherein each superblock includes up to several transform blocks;
a successive refinement compression module to determine, for each superblock, (i) which taps of said superblock are to be transmitted, and (ii) which taps are to be omitted from transmission due to their low energy level.

18. The low latency encoder of claim 17,
wherein the successive refinement compression module determines which taps to transit and which taps to omit from transmission under a condition that the total number of transmitted taps in a superblock is fixed;

19. The low latency encoder of claim 18, further comprising:
a frame buffer logic to process static blocks;
wherein for a static block, the successive refinement compression module is to divide all the transform taps to several phases; wherein in each frame a different part of the transform taps is transmitted.

20. The low latency encoder of claim 19, further comprising:
a compander module to implement a non-linear, monotonically non-decreasing function for companding output of the frame buffer logic and output of the successive refinement compression module.
